(19) United States
(12) Patent Application Publication
(10) Pub. No.: US 2007/0092433 A1
(43) Pub. Date: Apr. 26, 2007

(54) PROCESS FOR PRODUCING STABLE POLYALUMINUM HYDROXYCHLORIDE AND POLYALUMINUM HYDROXYCHLOROSULFATE AQUEOUS SOLUTIONS

(75) Inventors: Kevin Janak, Ossining, NY (US); Michael Thompson, Ballwin, MO (US)

Correspondence Address: ARTHUR J. PLANTAMURA;GENERAL CHEMICAL PERFORMANCE PRODUCTS LLC., 90 EAST HALSEY ROAD, PARSIPPANY, NJ, 07054, US

(73) Assignee: REHEIS, INC., Berkeley Heights, NJ (US)

(21) Appl. No.: 11/163,530

(22) Filed: Oct. 21, 2005

(51) Int. Cl. C01B 17/46

(52) U.S. Cl. 423/467

(57) ABSTRACT

The production of polyaluminum hydroxychlorosulfates (PACS) suitable for effective use as flocculants and coagulants in water treatment is described. The product is a fluid, clear solution that is stable with respect to precipitation and gelling for extended periods of time. Key features of the process include: i) the production of a PACS solution of about 12-16% Al₂O₃ and about 40-60% basicity at moderate temperatures (50-60° C.) using a zerovalent aluminum source, such as aluminum powder, ii) the addition of an alkali metal or alkali earth metal base at low temperatures (20-30° C.) to produce PACS products ranging from 9-12% Al₂O₃ with basicities ranging from 70-80%, iii) the addition of an alkali metal base at low temperatures without the use of high shear mixing, iv) a PACS product that does not contain significant amounts of the Al₁₃-mer Keggin complex , v) a product with greater than 80-95% of the aluminum polymers bimodally distributed in the range of 20,000-40,000 Daltons and 135-750 Daltons, and vi) the formation a PACS whereby greater than 95% of the sulfate is bound to aluminum and is contained in the aluminum polymers distributed in the range of 20,000-40,000 Daltons.

The invention relates to the production of polyaluminum hydroxychlorides (PAC) and polyaluminum hydroxychlorosulfates (PACS) suitable for use in water treatment applications and having a wide range of basicities.

### BACKGROUND OF THE INVENTION

Aluminum containing inorganic reagents such as alum (Al₂(SO₄)₃), polyaluminum hydroxychlorides (PAC), and polyaluminum hydroxychlorosulfates (PACS) are commonly used as flocculents and coagulants in municipal and industrial water and wastewater treatment. Although typically more expensive to manufacture than alum, PAC and PACS products are frequently found to work better than alum with regard to floc settling rates, cold water performance, and water pH adjustment. PAC and PACS products are typically described by the empirical formula:
Alₙ(OH)₃ₙ₋ₘ₋₂ₖ(SO₄)ₖClₘ
where n is the moles of aluminum, k is the moles of sulfate, and m is the moles of chloride in the product. The corresponding basicity of the product is defined as % Basicity={[OH—]/(3[Al³⁺])}×100, with the basicity calculated as the ratio [(3n-m-2k)/3n]×100. When an alkali metal base or an alkali earth metal base is used to adjust the final basicity of the PAC or PACS product, the empirical formula of the product can be amended in the following manner:
Alₙ(OH)_{3n+Zx-m-2k}(SO₄)ₖClₘYₓ,
where n is the moles of aluminum, k is the moles of sulfate, m is the moles of chloride, x is the moles of alkali metal or alkali earth metal and Z is the valence of the metal (e.g., 1 for Na⁺ and 2 for Mg²⁺). The basicity of the product is typically adjusted in order to account for desired stability, performance, and/or other product characteristics, with the basicity calculated as the ratio [(3n+Zx-n-2k)/3n]×100. In addition, PAC and PACS products are characterized by aluminum and aluminum sulfate polymers consisting of wide degrees of polymerization, with reported values ranging from the ˜1,000 Dalton Al₁₃-mer Keggin-type complex (see, for example, U.S. Pat. Nos. 5,985,234 and 5,997,838) to average molecular weight values of 7,000-35,000 Daltons, as described in U.S. Pat. No. 5,171,453.

A variety of processes have been reported describing methods for producing PAC and PACS chemical reagents for water treatment applications. For example, the above noted U.S. Pat. Nos. 5,985,234 and 5,997,838 describe a process whereby aluminum oxide trihydrate is reacted with hydrochloric acid and sulfuric acid at elevated temperature (115° C.) to form a polyaluminum hydroxychlorosulfate product which can be subsequently reacted with sodium aluminate under high shear mixing (˜1,000 Hz) at temperatures below 60° C. to produce a PACS of 50% -70% basicity and, at temperatures above 60° C., products of greater than 70% basicity. The high shear mixing involved in the process is a necessary component of the reaction. Further, it is described that the formation of significant amounts of smaller aluminum polymers, specifically the Al₁₃-mer Keggin complex, is an important component to the performance of the product. The requirement of high shear mixing is also mentioned in U.S. Pat. No. 4,877,597. The process involves the addition of an alkali metal aluminate to alum between 10° C.-35° C., followed by warming the reaction to 50° C.-90° C. This results in a PACS product with 7% -10% Al₂O₃, albeit with significant amounts of sodium sulfate by-product.

In addition, U.S. Pat. No. 5,603,912 describes a method of making a 50%-73% basicity PACS via an initial high temperature reaction of aluminum and aluminum chloride or hydrochloric acid, followed by reaction with sulfuric acid and then an alkaline earth carbonate such as calcium carbonate. Important features of the process of that patent include: i) the need to adjust the Al/Cl atomic ratio to 0.70-1.2 prior to sulfate ion addition, ii) initial preparation of the PACS at high temperature, and iii) addition of an alkaline earth carbonate (e.g., CaCO₃) at 45° C. Similarly, U.S. Pat. No. 5,246,686 discloses a process whereby an aluminum hydroxychlorosulfate is reacted with an alkaline earth carbonate, although at temperatures ranging from 60° C.-100C., to produce polyaluminum hydroxychlorosulfates with basicities in the range of 45%-70%. However, it is reported that the process results in the undesirable formation of insoluble gypsum.

A method that avoids the formation of gypsum and other alkaline earth sulfates is described in U.S. Pat. No. 5,348,721, requiring the initial production of a PACS of 40%-50% basicity at elevated temperature (140° C.) and pressure (2 bar), which is subsequently reacted with an alkaline metal carbonate (e.g., Na₂CO₃) or alkaline earth carbonate (e.g., CaCO₃) at temperatures in the range of 50° C.-70° C. to form PACS of 65%-75% basicity. Significantly, reaction with the selected base at lower temperatures (e.g., 40° C.), results in a product that is unstable with respect to the formation of a gel.

A low temperature process for the preparation of PACS is reported in U.S. Pat. No. 5,124,139 whereby aluminum trichloride is blended with alum at temperatures between 35° C.-50° C., followed by addition of a calcium base such as calcium carbonate, calcium oxide, or calcium hydroxide. However, in contrast to the process of the present invention, it was noted that products above 60% basicity made via the process of that patent are unstable and tend to solidify. In addition, reaction mixtures containing amounts of AlCl₃ and Al₂(SO₄)₃ such that initially prepared solutions with Al₂O₃ contents greater than 8.5% were reported to solidify even prior to addition of base. Finally, no example is given of a product made via the method of that patent containing concentrations of aluminum greater than 10% Al₂O₃.

### SUMMARY OF THE INVENTION

The invention involves the production of polyaluminum hydroxychlorosulfates (PACS) suitable for effective use as flocculants and coagulants in water treatment. The resulting product is a fluid, clear solution that is stable with respect to precipitation and gelling for extended periods of time. Key features of the process include: i) the production of a PACS solution of about 12%-16% Al₂O₃ and about 40%-60% basicity at moderate temperatures (50° C.-60° C.) using a zerovalent aluminum source, such as aluminum powder; ii) the addition of an alkali metal or alkali earth metal base at low temperatures (20° C.-45° C.) to produce PACS products ranging from 9-12% Al₂O₃ with basicities ranging from 70%-80%; iii) the addition of a soluble alkali metal or alkaline earth metal base at low temperatures without the use of high shear mixing to the aforementioned PACS solution to produce PACS products ranging from 9%-12% Al₂O₃ with basicities ranging from 70%-80%; iv) the production of a PACS solution of about 9-12% Al₂O₃ and about 60%-80% basicity at moderate temperatures (50° C.-60° C.) using a zerovalent aluminum source, such as aluminum powder, and without the use of a soluble alkali metal or alkaline earth metal base; v) the formation of an efficacious PACS product that does not contain significant amounts of the Al₁₃-mer Keggin complex (<15%), as determined by tandem size exclusion chromatography (SEC)/multi-angle laser light scattering (MALLS); vi) the formation of PACS solutions with greater than 80%-95% of the aluminum polymers distributed in the range of 20,000-40,000 Daltons and in the range of 135-750 Daltons; and vii) the formation a PACS whereby greater than 95% of the sulfate is bound to aluminum and greater than 95% of the sulfate is contained in the aluminum polymers distributed in the range of 20,000-40,000 Daltons, as determined by tandem size exclusion chromatography (SEC)/inductively coupled plasma (ICP) analytical techniques.

### BRIEF DESCRIPTION OF THE DRAWING

FIG. 1 is a graph from the analysis of the product of the invention indicating the characteristic bimodal distribution of aluminum polymers, whereby 35%-50% of the aluminum polymers are in the molecular weight range of 20,000-40,000 Daltons and 45%-60% of the polymers have molecular weights of 135-750 Daltons and illustrates the chromatographic separation and MALLS/RI detection of aluminum polymers in the PACS of the present invention using a 4.6×250 mm Cl column and nitric acid mobile phase.

FIG. 2 is a graph of a SEC/MALLS analysis of the product of the invention compared to the product made at higher temperature, emphasizing the importance of temperature control in the process.

FIG. 3 is a graph of a SEC/MALLS analysis indicating that the product of the invention is substantially devoid of free sulfate.

FIG. 4 is a graph of an SEC/ICP analysis of sodium sulfate, indicating the elution time of free sulfate.

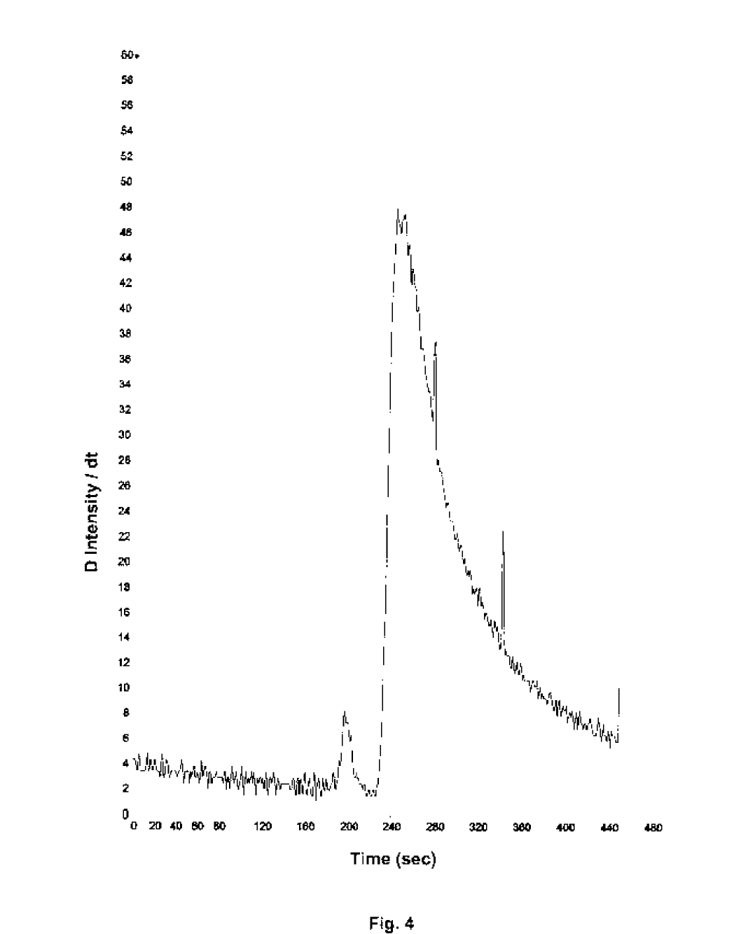

FIG. 5 is a graph of an SEC/ICP analysis of a commodity PACS product.

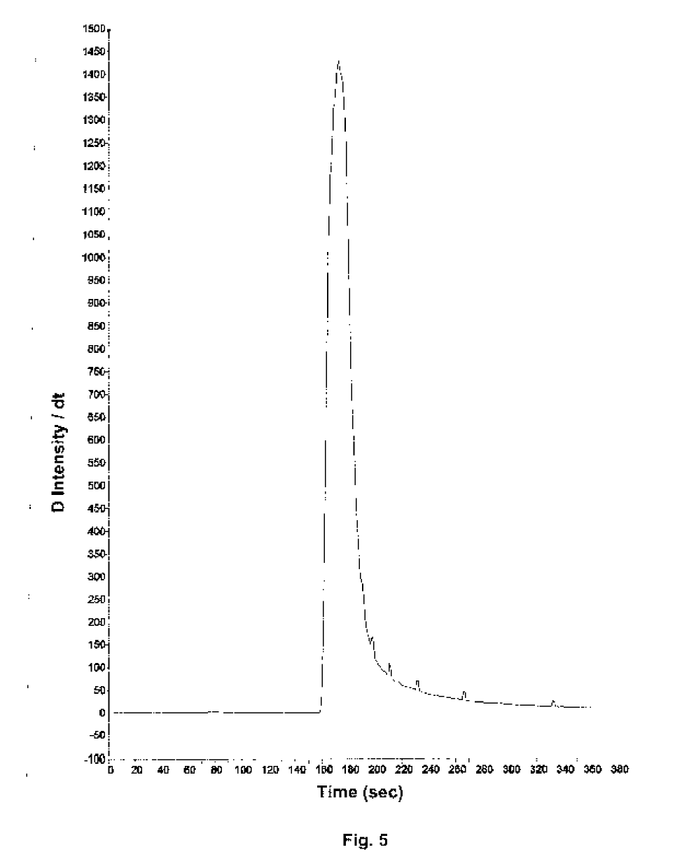

### DETAILED DESCRIPTION OF THE INVENTION

In the preferred embodiment of the invention, aluminum chloride is mixed with water and a sulfate source according to the desired concentration. The sulfate source may include, but is not limited to, sulfuric acid or alum. Further, the amount of the sulfate source used is chosen so as to produce a solution such that the final sulfate concentration is in the range of 0.5%-4%, more preferably 1%-3%, most preferably 1.5%-2.5%. The reaction mixture is warmed to a temperature of about 50° C.-60° C. and a zerovalent aluminum source such as, but not limited to, aluminum nuggets, comminuted aluminum metal, shredded metal sheeting and preferably aluminum powder is added such that an initial product of about 12%-16% Al₂O₃ is produced and the final product will contain an alumina (Al₂O₃) concentration of 9%-12%, more preferably 10%-12%, most preferably 10%-11%. The Al/Cl ratio is maintained in the range of 0.6-1.0, preferably 0.7-0.9, and most preferably 0.75-0.85. The mixture is then allowed to react for about 4-24 hours until the desired concentration is reached. This produces a PACS product with a basicity in the range of 40%-60%.

Subsequent to the production of the PACS, enhanced stability and performance can be imparted to the product by increasing the basicity of the product to 60%-85%, more preferably 65%-80%, and most preferably 70%-75%. In contrast to other known prior art, which typically require elevated temperatures and/or high shear mixing in order to maintain the stability of the system upon increasing the basicity, the present invention involves an effective and efficient process to increase the basicity and performance of the PACS by cooling the solution to 30° C. or below, followed by addition of an alkali metal base including, but not limited to, a soluble alkali metal carbonate, alkali metal bicarbonate, alkali earth-metal and mixtures thereof, preferred carbonates including sodium carbonate or sodium bicarbonate, as a solid, slurry, or solution. The resulting clear solution is adjusted with water to the desired % Al₂O₃ concentration and then filtered. Overall, the process provides a convenient means of producing a high basicity PACS product that is stable with respect to precipitation and gelling, does not result in the production and disposal of excess sulfate salts, and is of sufficiently low viscosity so as to simplify the production of PACS.

An alternate form of the process involves the preparation of the PACS of the present invention without the use of a soluble alkali metal or alkali earth metal base to achieve basicities greater than 70%. In such preparations, aluminum chloride is mixed with water and a sulfate source according to the desired concentration. The sulfate source may include, but is not limited to, sulfuric acid or alum. Further, the amount of the sulfate source used is chosen so as to produce a solution such that the final sulfate concentration is in the range of 0.5%-4%, more preferably 1%-3%, most preferably 1.5%-2.5%. The reaction mixture is warmed to a temperature of about 50° C.-60° C. and a zerovalent aluminum source such as, but not limited to, aluminum nuggets, comminuted aluminum metal, shredded metal sheeting and preferably aluminum powder is added such that the final product will contain an alumina (Al₂O₃) concentration of 9%-12%, preferably 10%-12%, and more preferably 10%-11%. The Al/Cl ratio is maintained in the range of 0.6-2.0, preferably 0.7-1.9, and more preferably 1.4-1.75. The mixture is then allowed to react for about 4-24 hours until the desired concentration is reached. This produces a PACS product with a basicity in the range of 40%-80%, preferably 65%-80%, and more preferably 70%-80%.

The polyaluminum hydroxychlorosulfates produced in accordance with the invention are characterized via high performance liquid chromatography (HPLC) using size exclusion chromatography (SEC) and multi-angle laser light scattering (MALLS). In SEC, polymers are separated on a column according to their relative average molecular weights and detected via a UV, refractive index, light scattering, and/or ICP detector. The identification and separation of aluminum polymers is well known, particularly in the antiperspirant industry (see, for example, U.S. Pat. Nos. 5,330,751, 5,356,612 and 5,356,609). Further, the use of light scattering techniques allows for the absolute determination of the average molecular weights of polymers in solution and can be combined with chromatographic separation in order to determine the molecular weights of different polymers in a particular matrix (see Wyatt, P. J., Analytica ChimicaActa 1993, 272, pp. 1-40).

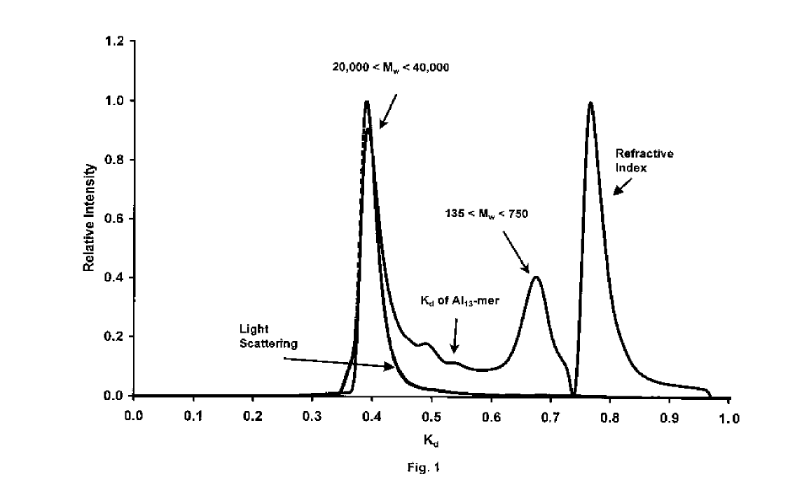

Known reports of the aluminum polymer distribution in PACS products include the aforementioned U.S. Pat. Nos. 5,985,234 and 5,997,838, which indicate that a polymer of approximately 1,000 Daltons, known as the Al₁₃-mer Keggin complex, is a key component to the overall performance of the product. Other prior art indicate that this species is a key component for efficient performance polyaluminum hydroxychloride and polyaluminum hydroxychlorosulfate water treatment chemicals (see, for example, the above mentioned U.S. Pat. No. 5,348,721; van Benschoten, J. E.; Edzwald, J. K., Wat. Res. 1990, 24, pp. 1519-1526; and Gao, B.; Ue, Q.; Wang, B., Chemosphere 2002, 46, pp. 809-813). This polymer and polymers of similar molecular weight are readily observed via size exclusion high performance liquid chromatography. Hence, SEC/MALLS analysis of the PACS produced according to the present invention indicates that less than 5% of the aluminum polymers are in this molecular weight range. Rather, the product of the present invention typically contains 35%-50% of the aluminum polymers in the molecular weight range of 20,000-40,000 Daltons while 45%-60% of the polymers have molecular weights of 135-750 Daltons (FIG. 1). Although U.S. Pat. No. 4,981,673 reports average molecular weight information for a PACS in the range of 7,000-35,000 Daltons, the data is for PACS of basicities ranging from 40%-65% and Al/Cl ratios from 2.8 to 5.

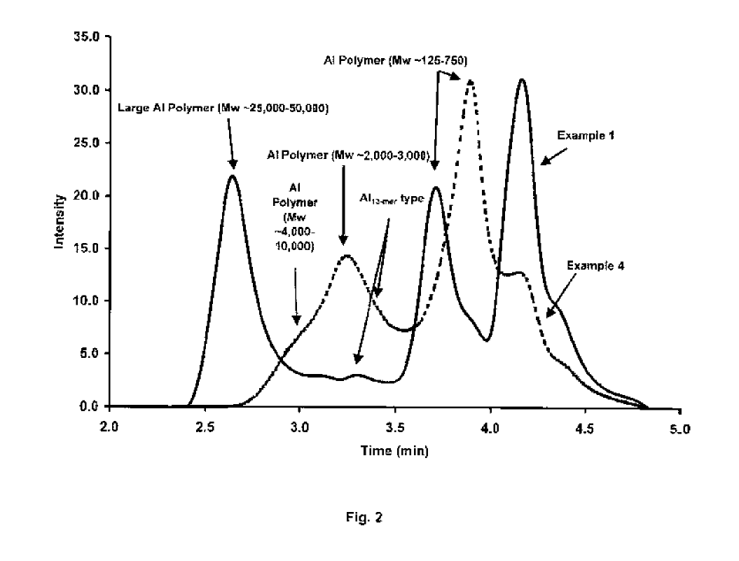

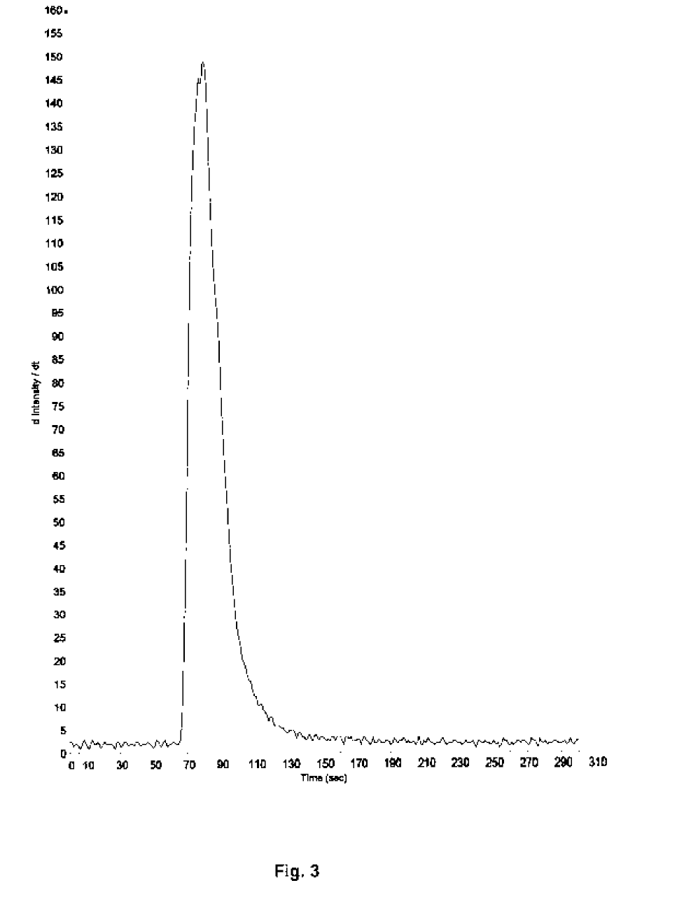

Analysis via SEC/ICP studies indicate that no free sulfate (<5%) exists in solution and that all of the sulfate is associated with aluminum polymers in the molecular weight range of 20,000-40,000 Daltons (FIG. 2), as determined via comparison of the retention time of the ICP signal to SEC/MALLS chromatograms of the PACS produced according to the present invention as well as comparison to SEC/ICP studies on sodium sulfate in order to identify the retention time of free sulfate ion (FIG. 3). Above noted U.S. Pat. No. 5,246,686 describes a PACS of 45%-70% basicity wherein more than 80% of the sulfate is complexed to aluminum, as determined via the BaSO₄ precipitation technique. However, the nature of the aluminum polymer distribution of that patent disclosure is not described and the types of aluminum polymers to which the sulfate is bound are not identified. Further, SEC/ICP analysis on alum (FIG. 3), a commodity product, indicates that greater than 95% of the sulfate is complexed to aluminum, but to low molecular weight aluminum species (<700 Daltons). Hence, the process of the present invention produces a PACS wherein the sulfate ion is bound selectively to high molecular weight aluminum polymers.

The following examples show the physical properties and characteristics of the PACS produced according to the method of the invention. These examples are intended as illustrative and should not be construed as placing a limitation on the scope of the invention.

### EXAMPLE 1

188 g of aluminum chloride is mixed with 120 g of water and 11 g of sulfuric acid (98%) at ambient temperature. The reaction mixture is heated to 50° C.-60° C. and 12 g of aluminum powder is added over a period of 2 hours. The reaction is continued for an additional 4 hours and then cooled to 25° C. 125 g of sodium carbonate solution (11.74% w/w) and 44 g of sodium bicarbonate were added over a 2 hour period. The mixture is stirred and filtered after dissolution of suspended material, resulting in a clear solution containing 10.65% Al₂O₃, 9.70% Cl, 1.97% SO₄, and a 70.5% basicity.

### EXAMPLE 2

160 g of aluminum chloride is mixed with 95 g of water and 8.2 g of sulfuric acid (98%) at ambient temperature. The reaction mixture is heated to 50° C.-60° C. and 13 g of aluminum powder is added over a period of 1 hour. The reaction is continued for an additional 12 hours and then cooled to 30° C. 104 g of sodium carbonate solution (22.0% w/w) is added over a 1.5 hour period. The mixture is stirred and filtered after dissolution of suspended material, resulting in a clear solution containing 10.91% Al₂O₃, 9.55% Cl, 2.10% SO₄, and a 68.8% basicity.

### EXAMPLE 3

160 g of aluminum chloride is mixed with 49 g of water and 8.2 g of sulfuric acid (98%) at ambient temperature. The reaction mixture is heated to 50-60° C. and 13 g of aluminum powder is added over a period of 1 hour. The reaction is continued for an additional 12 hours and then cooled to 30° C. 15 g of water is added, followed by 171 g of sodium carbonate solution (22.0% w/w) over a 2.5 hour period. The mixture is stirred and filtered after dissolution of suspended material, resulting in a clear solution containing 10.0% Al₂O₃, 8.81% Cl, 1.92% SO₄, and a 80.0% basicity.

### EXAMPLE 4

In order to illustrate the significance of the lower temperatures in the process of the present invention and the enhanced performance imparted thereby, an analogous polyaluminum hydroxychlorosulfate was prepared at high temperatures. 188 g of aluminum chloride is mixed with 120 g of water and 11 g of sulfuric acid (98%) at ambient temperature. The reaction mixture is heated to 80° C.-90° C. and 12 g of aluminum powder is added over a period of 2 hours. The reaction is continued for an additional 3 hours and then 125 g of sodium carbonate solution (11.74% w/w) and 44 g of sodium bicarbonate over a 2 hour period. The mixture is stirred and filtered after dissolution of suspended material, resulting in a clear solution containing 10.82% Al₂O₃, 9.27% Cl, 2.06% SO₄, and a 72.7% basicity.

### EXAMPLE 5

119 g of aluminum chloride is mixed with 100 g of water and 6.42 g of alum at ambient temperature. The reaction mixture is heated to 50-60° C. and 9.75 g of aluminum powder is added. The reaction is continued for an additional 22 hours and then cooled to 30° C. 65 g of sodium carbonate solution (27.6% w/w) over a 2 hour period. The mixture is stirred and filtered after dissolution of suspended material, resulting in a clear solution containing 10.76% Al₂O₃, 9.36% Cl, 1.95% SO₄, and a 78.2% basicity.

### EXAMPLE 6

200 g of aluminum chloride is mixed with 137 g of water and 11.0 g of sulfuric acid at ambient temperature. The reaction mixture is heated to 50-60° C. and 16 g of aluminum powder is added. The reaction is continued for an additional 15 hours and then cooled to 30° C. 136 g of a magnesium carbonate slurry (21.3% w/w) over a 2 hour period. The mixture is stirred and filtered after dissolution of suspended material, resulting in a clear solution containing 10.28%Al₂O₃, 9.06% Cl, 2.11% SO₄, and a 73.2% basicity.

### EXAMPLE 7

This examples illustrates the preparation of the product according to the process of this invention without the use of a soluble metal carbonate base. 91 g of aluminum chloride is mixed with 283 g of water and 8.52 g of sulfuric acid (98%) at ambient temperature. The reaction mixture is heated to 50-60° C. and 17 g of aluminum powder is added over a 1-2 hour period. The reaction is continued for an additional 21 hours and then cooled to ambient temperature. The mixture is filtered, resulting in a clear solution containing 10.5% Al₂O₃, 4.49% Cl, 2.09% SO₄, and a 72.5% basicity.

The following table summarizes the aluminum polymer distribution within the product of the present invention.

| | Molecular Weight Range (Daltons) | | | |
|---|---|---|---|---|
| | 20,000-40,000 | 2,000-10,000 | 750-2,000 | 135-750 |
| % Al | 41.65 | 10.23 | 10.31 | 37.82 |
| Composition | | | | |
| (Example 1) | | | | |
| % Al | 41.57 | 10.34 | 8.12 | 39.97 |
| Composition | | | | |
| (Example 5) | | | | |
| % Al | 43.57 | 8.20 | 13.50 | 34.73 |
| Composition | | | | |
| (Example 7) | | | | |

The following table illustrates the use of the polyaluminum hydroxychlorosulfate of the present invention as an effective water treatment chemical. Jar tests were conducted on an equal % Al₂O₃ basis and involved rapid agitation (220 rpm) of the test water for ˜1 second after coagulant addition, followed by slow mixing (40 rpm) for 15 minutes and 20 minutes for floc settling.

| | | | | First | | | |
|---|---|---|---|---|---|---|---|
| | | Water | Final | Floc | | | Water |
| | Test Water | Turbidity | Turbidity | Time | Water | Final | Temp |
| Sample | Location | (NTU) | (NTU) | (min) | pH | pH | (° C.) |
| Example 1 | Brantford, ON | 6.4 | 0.83 | 30 | 8.33 | 7.92 | 3.0 |
| Example 4 | Brantford, ON | 6.4 | 1.65 | 110 | 8.33 | 7.87 | 3.0 |
| Holland | Brantford, ON | 6.4 | 0.96 | 25 | 8.33 | 7.96 | 3.0 |
| Example 1 | Grand Rapids, | 1.8 | 0.36 | 45 | 8.44 | 8.22 | 4.0 |
| | MI | | | | | | |
| Holland | Grand Rapids, | 1.8 | 0.53 | 110 | 8.44 | 8.12 | 4.0 |
| | MI | | | | | | |
| Example 1 | White House, TN | 6.1 | 0.69 | — | 7.80 | — | — |
| Example 5 | White House, TN | 6.1 | 0.56 | — | 7.80 | — | — |
| Example 7 | White House, TN | 6.1 | 0.48 | — | 7.80 | — | — |

The following table illustrates the stability of the PACS produced according to the present invention in terms of solution turbidity.

| Aging Period | Turbidity (NTU) |
|---|---|
| 0 month | 13.2 |
| 1 month | 15.8 |
| 3 months | 23.0 |
| 7 months | 67.2 |

The invention has been described in terms of particular embodiments. However, it would be apparent to those skilled in the art that various alternatives and substitutes may be applied from the disclosure herein provided. It will be understood, accordingly, that the invention is not to be limited to the details described herein, unless so required by the scope of the appended claims.

What is claimed is:

1. A process for preparing an aqueous solution of a polyaluminum hydroxychlorosulfate (PACS) which comprises:
a. mixing a solution of aluminum chloride and sulfuric acid and heating said solution mixture to a temperature within the range of 40° C.-70° C.;
b. adding a zerovalent aluminum source to the acid solution and reacting the aluminum containing solution at a temperature below about 70° C. until an aqueous polyaluminum hydroxychlorosulfate solution, having about 12%-16% Al₂O₃ and having the formula,
Alₙ(OH)₃ₙ₋ₘ₋₂ₖ(SO₄)Clₘ
where n is the moles of aluminum, k is the moles of sulfate, m is the moles of chloride and a basicity expressed as the ratio
[(3n-m-2k)/3n]×100
in the range for 40%-60% is produced; and where k, m and n have the above expressed values;
c. cooling the resulting polyaluminum hydroxychlorosulfate product to below about 40° C.;
d. adding a basic compound selected from an alkali metal carbonate, alkali metal bicarbonate, soluble alkaline earth metal carbonate, and mixture thereof, to the reaction mixture; and
e. recovering the aqueous polyaluminum hydroxychlorosulfate product solution having the formula
Alₙ(OH)_{3n+Zx-m-2k}(SO₄)ₖClₘYₓ,
where k, n, Z and m have the above expressed value and x is the moles of alkali metal or alkaline earth metal such that the basicity is expressed as the ratio
[(3n+Zx-m-2k)/3n]×100
and ranges from about 60%-80% and k, m and n have the above expressed values.

2. The process as defined in claim 1 wherein the zerovalent aluminum source is aluminum powder.

3. The process as defined in claim 1 wherein the zerovalent aluminum source is comminuted aluminum metals.

4. The process as defined in claim 1 wherein the Al/Cl ratio of the solution is within the range of 0.6-1.0.

5. The process of claim 4 wherein the Al/Cl ratio of the solution is within the range of 0.75-0.85.

6. The process as defined in claim 1 wherein the product solution contains an alumina (Al₂O₃) concentration of 9%-12%.

7. The process of claim 6 wherein the product solution contains alumina (Al₂O₃) concentration of about 10%-11%.

8. The process as defined in claim 1 wherein the product basicity is about 65%-80%.

9. The process as defined in claim 8 wherein the product basicity is about 70%-75%.

10. The process as defined in claim 1 wherein the reaction is maintained until a PACS is produced containing greater than 80-95% of the aluminum polymers distributed in the range of 20,000-40,000 Daltons and in the range of 135-750 Daltons.

11. The process as defined in claim 1 wherein greater than 95% of the sulfate is bound to aluminum and is contained in the aluminum polymers distributed in the range of 20,000-40,000 Daltons, as determined by SEC/ICP analysis.

12. A process for preparing an aqueous solution of a polyaluminum hydroxychlorosulfate (PACS) which comprises:
a. mixing a solution of aluminum chloride and sulfuric acid and heating said solution mixture to a temperature within the range of 50° C.-60° C.;
b. adding a zerovalent aluminum source to the acid solution and reacting the aluminum containing solution at a temperature below about 60° C. until an aqueous polyaluminum hydroxychlorosulfate solution, having about 9%-12% Al₂O₃ and having the formula,
Alₙ(OH)₃ₙ₋ₘ₋₂ₖ(SO₄)ₖClₘ
where n is the moles of aluminum, k is the moles of sulfate, m is the moles of chloride and a basicity expressed as the ratio
[(3n-m-2k)/3n]×100
in the range for 60%-80% is produced; and where k, m and n have the above expressed values.

13. The process of claim 12 wherein the aluminum source is selected from powdered and comminuted aluminum and wherein the Al/Cl ratio of the solution is within the range of 0.6-2.5.

14. The process of claim 12 wherein the reaction is maintained until the product solution contains an alumina (Al₂O₃) concentration of about 9% to 12%.

15. The process as defined in claim 14 wherein the product basicity is about 70%-75%.

16. The process as defined in claim 12 wherein the reaction is maintained until a PACS is produced containing greater than 80-95% of the aluminum polymers distributed in the range of 20,000-40,000 Daltons and in the range of 135-750 Daltons.

17. The process as defined in claim 12 wherein greater than 95% of the sulfate is bound to aluminum and is contained in the aluminum polymers distributed in the range of 20,000-40,000 Daltons, as determined by SEC/ICP analysis.

18. A product produced by the process of claim 1.

19. A product produced by the process of claim 3.

20. A product produced by the process of claim 5.

21. A product produced by the process of claim 7.

22. A product produced by the process of claim 9.

23. A product produced by the process of claim 11.

24. The product produced by the method of claim 12.

25. The product produced by the method of claim 13.

26. The product produced by the method of claim 14.

27. The product produced by the method of claim 15.

28. The product produced by the method of claim 16.

29. The product produced by the method of claim 17.
